(19) United States
(12) Patent Application Publication
(10) Pub. No.: US 2011/0153709 A1
(43) Pub. Date: Jun. 23, 2011

(54) DELAY OPTIMAL COMPRESSOR TREE SYNTHESIS FOR LUT-BASED FPGAS

(76) Inventors: Juinn-Dar HUANG, Zhubei City (TW); Jhih-Hong Lu, Pingtung County (TW); Bu-Ching Lin, Taichung County (TW); Jing-Yang Jou, HsinChu City (TW)

(21) Appl. No.: 12/717,520

(22) Filed: Mar. 4, 2010

(30) Foreign Application Priority Data
Dec. 23, 2009 (TW) 098144372

(51) Int. Cl. G06F 7/50

(52) U.S. Cl. 708/700

(57) ABSTRACT

A compressor tree synthesis algorithm, named DOCT, which guarantees the delay optimal implementation in LUT-based FPGAs. Given a targeted K-input LUT architecture, DOCT firstly derives a finite set of prime patterns as essential building blocks. Then, it shows that a delay optimal compressor tree can always be constructed by those derived prime patterns via integer linear programming (ILP). Without loss of delay optimality, a post-processing procedure is invoked to reduce the number of demanded LUTs for the generated compressor tree design. DOCT has been evaluated over a broad set of benchmark circuits. The DOCT reduces the depth of the compressor tree and the number of LUTs based on the modern 8-input LUT-based FPGA architecture.

### FIELD OF THE INVENTION

The present invention relates to a compressor tree synthesis algorithm, it specifically relates to a Delay Optimal Compressor Tree Synthesis Algorithm applied in lookup table based (LUT-based) FPGA.

### BACKGROUND OF THE INVENTION

The prior art compressor tree synthesis can be divided into two main categories, one is to develop algorithm under the original LUT-based FPGA so as to use effectively the lookup table to construct compressor tree. In the second type, an operation unit is embedded in the original architecture so as to replace the compressor tree. Wherein the method with embedded operation unit must change the original architecture, hence, it can not be applied directly the current LUT-based FPGA.

FIG. 1 illustrates the compressor tree operation in the prior art application specific integrated circuit (ASIC), and the patterns it used are half adder and full adder. As shown in FIG. 1, the operation unit height needs to be added in zeroth layer is three, which cannot be sent to carry propagation adder (CPA), hence, it needs to be compressed first by full adder or half adder so that the height of operation unit to be added is reduced to two to generate the output result of the first layer, then the operation unit of the first layer can be calculated directly through carry propagation adder to get the sum, and the construction of compressor tree is then completed. For related technology, please refer to U.S. Pat. No. 5,343,416, U.S. Pat. No. 6,701,339 and U.S. Pat. No. 6,567,834 and U.S. Patent application No. U.S. 2007/0192398.

Different than application specific integrated circuit, the pattern that LUT-based FPGA can be applied to be more diversified, which is not limited to half adder and full adder. Therefore, in this invention, delay optimal compressor tree synthesis algorithm for FPGA is proposed, which uses lookup table to define finite amount of prime pattern so as to enhance the compressor tree efficiency of lookup table FPGA. That is, the digital signal processing application circuit realized in LUT-based FPGA is accelerated.

### SUMMARY OF THE INVENTION

The main objective of the present invention is to propose a Delay Optimal Compressor Tree Synthesis Algorithm to be applied in LUT-based FPGA.

Based on the present invention, a LUT-based FPGA Delay Optimal Compressor Tree Synthesis Algorithm is proposed wherein the input limitation of the lookup table is n, and the algorithm includes the definition of pattern with input limitation of n; then based on the pattern, the pattern set of input limitation of n is defined; then based on the pattern set, union of pattern set with input limitation of smaller than or equal to n is defined; then from union of the pattern set, prime pattern that can not be disassembled by other pattern is defined; then based on the prime pattern, prime pattern set with input limitation of n is defined; wherein, the pattern set includes the pattern, the union of the pattern set includes the pattern set, the prime pattern set is for the operation of the compressor tree.

In a better case, accompanied with integer linear programming, least prime pattern is used from prime pattern set so as to reduce lookup table unit and to reduce the area needed by compressor tree and enhance its efficiency. With the following detailed descriptions and attached figures, advantages and essences correlated with this invention can be further realized.

### BRIEF DESCRIPTION OF THE DRAWINGS

FIG. 1 illustrates the prior art compressor tree operation in application specific integrated circuit;

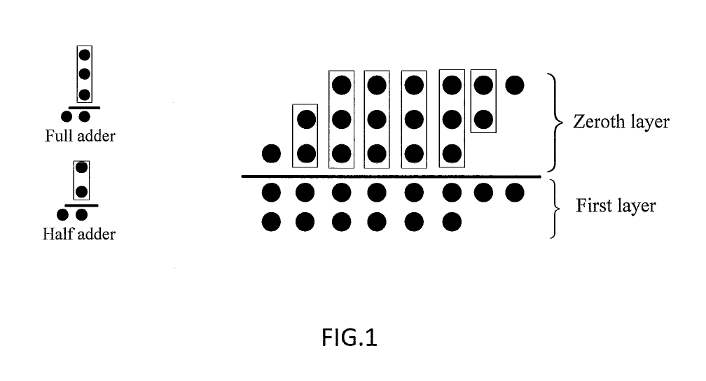

FIG. 2 is a drawing showing the pattern, pattern set, union of pattern sets, prime pattern and union of prime patterns defined at input limitation of 3 in lookup table; and

FIG. 3 illustrates one embodiment of the present invention.

### DETAILED DESCRIPTION OF THE PREFERRED EMBODIMENTS

Among many digital signal processing (DSP) applications, there are many parts that will use compressor tree to aggregate multiple variables, and these applications include: multiplier, Multiplier and Accumulator (MAC), Discrete Cosine Transform (DCT), finite pulse impulse response (FIR) filter and motion estimation, etc. To enhance the speed of the realization implementation of the above application circuits in LUT-based FPGA, a high speed compressor tree architecture is mandatory required to aggregate multiple variable. In the present invention, under the given input limitation of lookup table, a set of corresponding prime pattern set is generated, then through these prime patterns, integer linear programming is used to synthesize delay optimal compressor tree. Moreover, without losing the delay optimal characteristic, a set of post-procedure is used to reduce the area needed by the compressor tree. In the current process, the input limitation of lookup table can be as high as eight; to simplify the explanation, in the following embodiment, the input limitation of lookup table of three is used.

According to the present invention, to synthesize delay optimal compressor tree, it is not necessary to consider all the possible patterns, only all the prime patterns need to be considered. Prime pattern is decided according to the design architecture of each lookup table; however, in the physical meaning, prime pattern must have the probability of digit propagation in each row.

The prime pattern definition steps proposed in the present invention include:

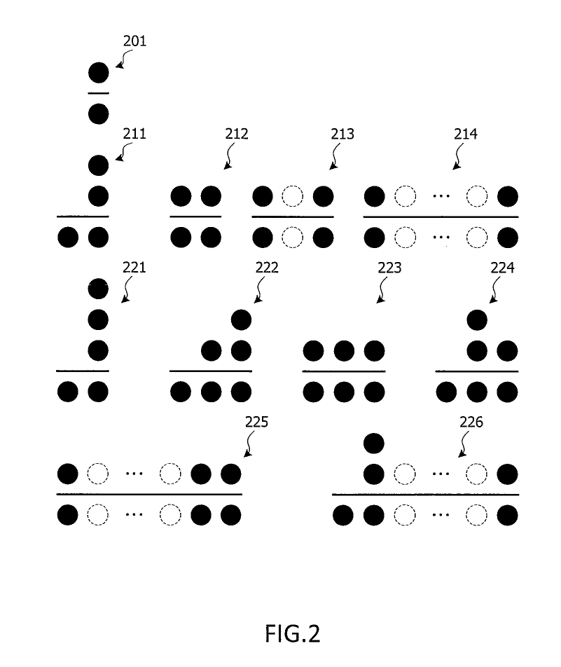

Definition of pattern: The so-called pattern in the present invention means, under the input limitations, a compression architecture that lookup table can be implemented; however, even under the same input limitation, multiple compression architectures can be generated, for example, pattern 221, 222, 223, 224, 225 and 226 of FIG. 2, the input limitation of these six patterns is three.

Definition of sets of patterns (PS): The so-called pattern set in the present invention means, under the same input limitation, all the possible patterns, for example, pattern 221, 222, 223, 224, 225 and 226 of FIG. 6 all belong to the same pattern set.

Definition of union of pattern sets (UPS): The so-called union of pattern sets of the present invention means, under the satisfaction of input limitation condition, all the possible union of pattern sets generated by pattern obtained in step b, for example, in FIG. 2, all the inputs of pattern 201, 211, 212, 213, 214, 221, 222, 223, 224, 225 and 226 are all smaller than or equal to three, which belong to union of pattern sets with input limitation of three.

Definition of prime pattern (PPS): The so-called prime pattern of the present invention means, under the same input limitation, the most basic architecture that lookup table can realize; that basic architecture can not be replaced by other prime pattern, as in FIG. 2, pattern 211 is a prime pattern, but pattern 222 can be divided into two 201, therefore, pattern 222 is not a prime pattern.

Definition of union of prime pattern (UPPS): The so-called union of prime pattern means, under the same input limitation, all the possible unions of prime pattern, for example, as in FIG. 2, pattern 201, 211, 221 and 222 belong to union of prime pattern with input limitation of 3.

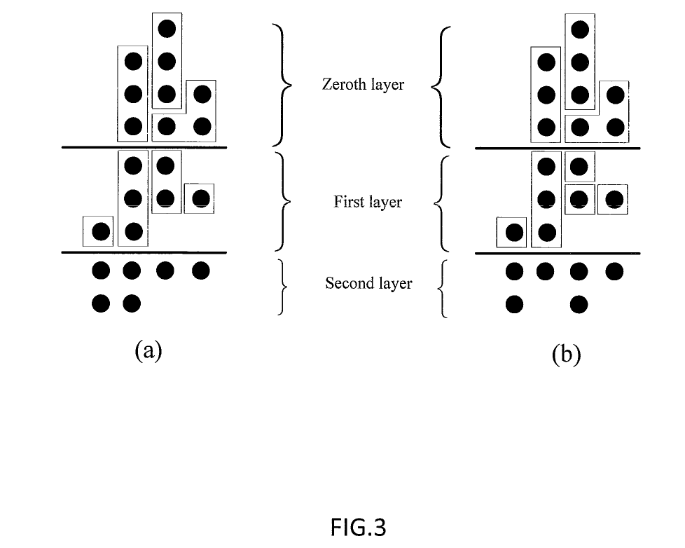

Under the input limitation of 3 of lookup table, according to the above mentioned step, we can obtain four prime patterns 201, 211, 221 and 222 as FIG. 2. FIG. 3 (a) and FIG. 3(b) is an illustration according to one embodiment of the present invention, and the compressor tree of FIG. 3 (a) is constructed under the input limitation of 3 of lookup table, then through the four prime patterns 201, 211, 221 and 222 of FIG. 2, the zeroth layer with height of operation unit of 4 is compressed for the first time to generate the first layer of height of operation unit of 3, but the height of the first layer is still larger than 2, hence, one more compression is needed to generate second layer with height of operation unit of 2.

In the embodiment of FIG. 3(a), after the subtraction of prime pattern p1, a total of five lookup table units is used, hence, for the present invention, under the premise not to lose delay optimal, a set of post-procedures is proposed to reduce the area needed by compressor tree, hence, after finding delay optimal compressor tree design, it might be found that multiple prime patterns can be merged into the same lookup table, hence, in the post-procedures, greedy search method is used to merge arbitrarily the prime patterns that can be merged into the same lookup table. Through the post-procedures, the redundant prime pattern in the second layer (counted from the last one) is then removed. After the extraction of the delay optimal compressor tree of FIG. 3(a) by the post-procedures, the corresponding compressor tree is going to be as in FIG. 3(b). As shown in FIG. 3(b), after optimization, only four lookup tables are needed.

As compared to the existed algorithm, the algorithm proposed in this invention can reduce the delay by about 32% and the area by about 21%, that is, the performance of LUT-based FPGA in realizing high speed compressor tree can be greatly enhanced.

According to the present invention, under the condition that the input limitation of lookup table is 6, the number of prime pattern is 37, in other words, we only need to consider these 37 prime patterns in order to synthesize delay optimal compressor tree.

The algorithm proposed in the present invention can be realized in software, firmware or hardware. Although the present invention is disclosed through a better embodiment as above, yet it is not used to limit the present invention, anyone that is familiar with this art, without deviating the spirit and scope of the present invention, can make any kinds of change, revision and finishing; therefore, the protection scope of the present invention should be based on the scope as defined by the following attached “what is claimed”.

What is claimed is:

1. A Delay Optimal Compressor Tree Synthesis Algorithm used in LUT-based FPGA wherein the input limitation of the lookup table is n and the algorithm includes the following steps:
a. Based on the input limitation n and the lookup table, pattern is defined;
b. Based on the pattern, pattern set of the input limitation of n is defined;
c. Based on the pattern set, union of pattern set with input limitation smaller than or equal to n is defined;
d. From the union of pattern set, prime pattern that can not be disassembled by other pattern is defined; and
e. Based on the prime pattern, union of prime pattern with input limitation n is defined;
Wherein the pattern set includes the pattern, the union of the pattern set includes the pattern set, and the union of the prime pattern is for the operation of the compressor tree.

2. The algorithm of claim 1 wherein it further includes accompanying integer linear programming to decide the most appropriate compressor tree from the prime pattern set.

3. The algorithm of claim 1 wherein n is positive integer that is smaller than or equal to 8.

4. The algorithm of claim 1 wherein it further includes, after the finding of appropriate compressor tree, the use of greedy search method to merge arbitrarily prime pattern that can be merged into the same lookup table.
